(19) United States
(12) Patent Application Publication
(10) Pub. No.: US 2012/0121875 A1
(43) Pub. Date: May 17, 2012

(54) DOUBLE LAYERED UNIAXIALLY ELONGATED FOAM POLYMER MEMBRANE STRUCTURE

(76) Inventor: HSIN-LI LIN, Daxi Township (TW)

(21) Appl. No.: 12/945,645

(22) Filed: Nov. 12, 2010

(51) Int. Cl. B32B 7/02

(52) U.S. Cl. 428/213

(57) ABSTRACT

A double layered uniaxially elongated foam polymer membrane structure includes a first basic material and a second basic material of different thickness. The elongated foam granules contained in the first basic material are larger than those contained in the second basic material the elongated foam granules of the second basic material are formed into a cylindrical strip, and the two basic materials are bonded together by welding. With this structure the incident and reflection light angles may be kept optimistically maximum.

### BACKGROUND OF THE INVENTION

1. Field of the Invention

The present invention relates to a double layered uniaxially elongated foam polymer membrane structure which is to be used for forming a light reflection material.

2. Description of the Prior Art

In the night, as the brightness of an object reduced, the visibility of human eyes is affected. That means the amount of reflected light from surrounding object, which the optical nerves of the human eyes rely on to identify the object becomes insufficient to form a clear image on the retina. In other words under the condition of insufficient illumination in the night time, the intensity of the reflection light from the objects is weakened so that people can not observe the object clearly because the visibility of eyes is lowered.

The light reflection material is able to intensify the reflection power of the reflection surface so as to aid the visibility of the human eyes at night. In the prior arts the granulated glass or the metal plated layer can be applied to intensify the light reflection ability to achieve such as a warning effect. As shown in FIG. 1, there is a reflector material whose surface is formed of numerous glass granules A1 to form a membrane A. The incident light B to the glass granules A1 is then reflected therefrom. Meanwhile there is a flaw that part of the incident light B which radiates the clearances A2 among the glass granules A1 fails to reflect and reduces effective reflection light.

Although remedy can be made by increasing the layers of the glass granules A1, yet the spherical glass granules A1 are so tiny to fill out those rather large clearances A2 satisfactorily even the layers of the glass granules A1 are doubled, the light leakage is still inevitable.

For this defect noticeable on the prior arts, a remedy is seriously required. It is therefore necessary for us to continue study to meet the challenge. The inventor of this invention has dedicated great effort for years to studying and improving this defect and come up with the ingenious double layered uniaxially elongated foam polymer membrane structure which will be disclosed hereinafter.

### SUMMARY OF THE INVENTION

It is an object of the present invention to provide a double layered uniaxially elongated foam polymer membrane structure which can offer a maximum reflection angle for the incident light.

It is another object of the present invention to provide a double layered uniaxially elongated foam polymer membrane structure in which a filler is added to improve the light reflectivity.

To achieve the above objects, the present invention comprises a first and a second basic materials of different thickness, wherein the first one has larger elongated foam granules, while the second one's elongated foam granules form cylindrical shape strips. Both basic materials are bonded by welding. With such a double layered structure, the incident and reflection light angles are kept optimistically maximum value.

In the above polymer membrane structure, the basic materials are respectively formed of uniaxial foam polydactyl and uniaxial foam polyvinyl.

In the above polymer membrane structure, both basic materials have a specific weight of 0.8˜0.4.

In the above polymer membrane structure, both basic materials have a thickness of 80˜300 um.

In the above polymer membrane structure, a filler is added in the welding process.

In the above polymer membrane structure, the filler is selected one from the group consisting of mixtures of silicon dioxide with silver sulfate, and titanium dioxide with silver sulfate.

In a word, it emerges from the above description that the present invention has several noteworthy advantages compared with the prior arts, namely:

1. The first basic material has larger granules which form larger elongated irregular cylindrical shape, while the second one has smaller granules forming shorter elongated irregular cylindrical shape. With this structure, the optimistic maximum incident and reflection angle are obtained by combining them in two layers.

2. The two basic materials are welded together by adding a filler which can improve the light reflectivity.

3. The elongated foam granules are larger and longer to minimize the clearances among the granules thereby avoiding leakage of the incident light as less as possible and intensifying the reflectivity.

### BRIEF DESCRIPTION OF THE DRAWINGS

The drawings disclose an illustrative embodiment of the present invention which serves to exemplify the various advantages and objects hereof, and are as follows:

FIG. 1 is a cross sectional view of the light reflection surface formed of a conventional reflection material.

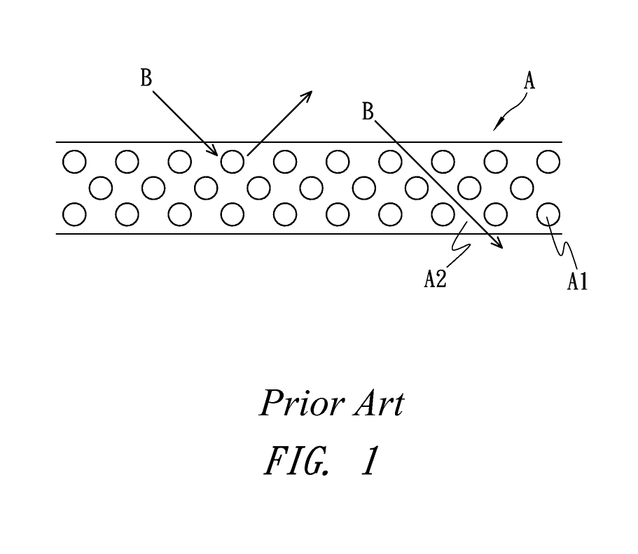

FIG. 2 is a transverse cross sectional view of the light reflection surface according to the present invention.

FIG. 3 is an illustrative view showing a strip shaped decoration formed of the light reflection material according to the present invention.

### DETAILED DESCRIPTION OF THE PREFERRED EMBODIMENT

Detailed description of a preferred embodiment of the present invention will be made with reference to the accompanied drawings hereinafter.

The light reflection materials of the present invention comprise mainly a first basic material and a second basic material. Wherein the first one has thicker and larger, fish eye like elongated foam granules, while the second one contains elongated foam granules in cylindrical shape. As a result, the thickness of the second basic material is smaller than that of the first one. The first and the second basic materials are bonded together by welding.

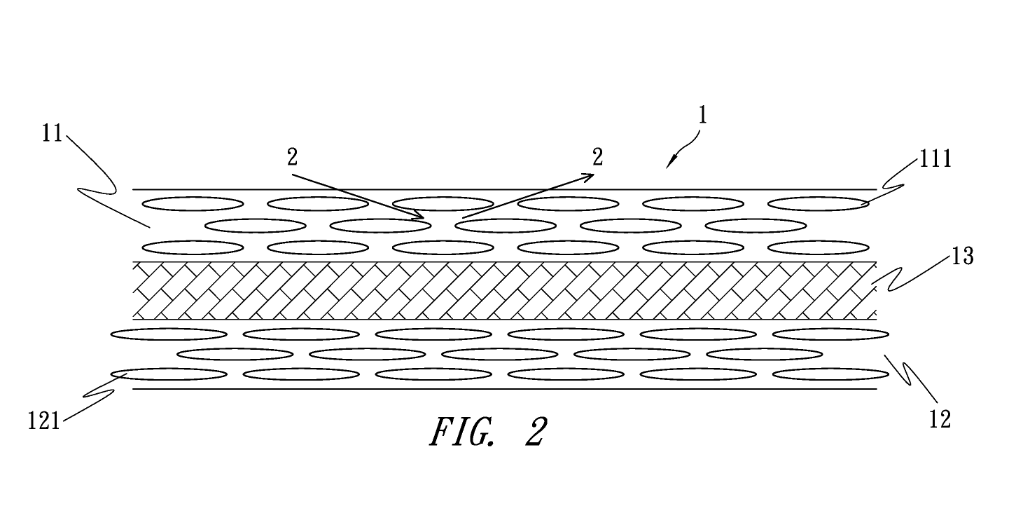

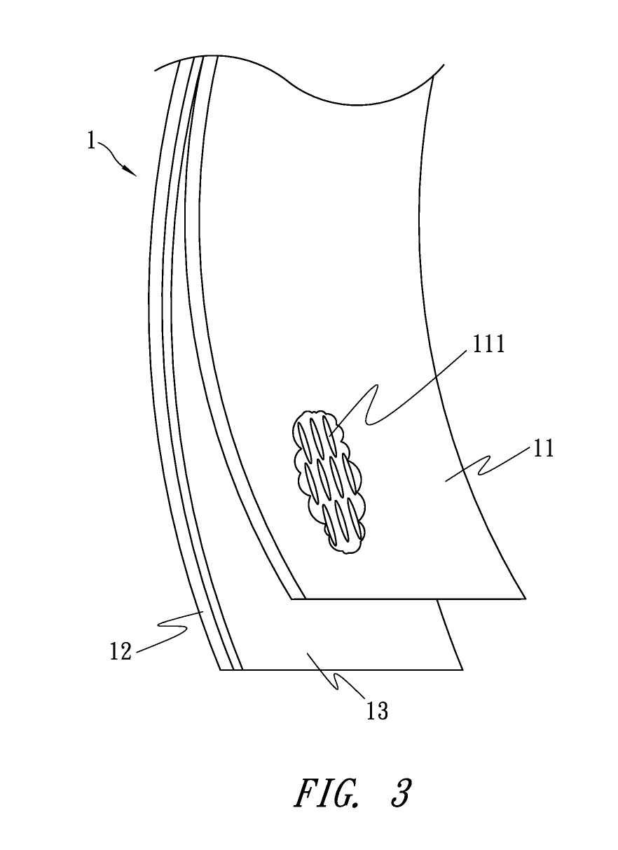

As showing in FIG. 2 and FIG. 3, in a preferred embodiment of the present invention, the polymer membrane structure 1 is composed of the first basic material 11, a filler 13 and the second basic material 12. The elongated foam granule 111 contained in the first basic material 11 is larger compared with that contained in the first basic material and formed into fish eye like figure. The elongated foam granules 111 are stacked in multiple layers such that clearances can not be formed between adjacent elongated foam granules 111 contained respectively in upper and lower layers, namely, the clearance between the adjacent two granules 111 of the first layer will be filled with the granule 111 of the second layer. With this structure the incident angle of the incident light 2 can be made larger.

Similarly, the cylindrical shaped elongated foam granules 121 contained in the second basic material 12 are stacked in multiple layers too, and there is no room for the clearance to exist between the adjacent granules 121 of the upper and lower layers since the clearance between the adjacent two granules 121 in the first layer is filled by granule 121 in the second layer. Moreover, a filler 13 is added in the welding process during bonding two basic materials 11 and 12 together in the manner the filler 13 is intercalated between upper first basic material 11 and lower second one 12 (see FIG. 3). The filler 13 is selected one from the group consisting of mixtures of silicon dioxide with silver sulfate, and titanium dioxide with silver sulfate.

As the elongated foam granules 111 contained in the first basic material 11 are larger and formed in a fish eye-like figure, whereas the elongated foam granules 112 contained in the second basic material 12 are formed in cylindrical strip, the optimistically maximum value of incident and reflection angle can be obtained for the polymer membrane 1. When the two basic materials 11 and 12 are bonded, additional application of the filler 13 serves to avoid leaking of the incident light B from the clearances.

As shown in FIG. 3, the novel reflection material provided by the present invention can be used in a strip shaped decoration for a package substance.

It is apparent to a person skilled in the art that the basic idea of the invention can be implemented in many different ways. The invention and its embodiment are not restricted to the example described above, but may vary with the scope of the appended claims.

What is claimed is:

1. A double layered uniaxially elongated foam polymer membrane structure comprising: a first basic material and a second basic material of different thickness, wherein elongated foam granules contained in said first basic material are larger than those contained in said second basic material, the elongated foam granules of said second basic materials are formed into a cylindrical strip, and said two basic materials are bonded together by welding.

2. The foam polymer membrane structure of claim 1, wherein said first and said second basic materials are respectively formed of uniaxial foam polyactyl and uniaxial foam polyvinyl.

3. The foam polymer membrane structure of claim 1, wherein said first and said second basic materials have a specific weight of 0.8˜0.4.

4. The foam polymer membrane structure of claim 1, wherein said first and said second basic materials have a thickness of 80˜300 um.

5. The foam polymer membrane structure of claim 1, wherein a filler is added in the welding process.

6. The foam polymer membrane structure of claim 5, wherein said filler is selected one from the group consisting of silicon dioxide with silver sulfate and titanium dioxide with silver sulfate.
